(19) United States
(12) Patent Application Publication
(10) Pub. No.: US 2005/0195742 A1
(43) Pub. Date: Sep. 8, 2005

(54) Packet scheduler for access networks

(75) Inventors: Joshua Klipper, Netanya (IL); David Rouchbach, Pardesia (IL); Ronit Bensky, Hod hasharon (IL); Yossi Ben-Sason, Moki'in (IL)

Correspondence Address: Fogg and Associates, LLC, P.O. Box 581339, Minneapolis, MN, 55458-1339, US

(73) Assignee: ADC Telecommunications Israel Ltd.

(21) Appl. No.: 10/793,572

(22) Filed: Mar. 4, 2004

(51) Int. Cl. H04L 1/00

(52) U.S. Cl. 370/235

(57) ABSTRACT

A scheduler block that schedules and shapes packets such as ATM cells. The scheduler block includes multiple queues. Each queue is associated with a physical layer device. Each queue stores packets intended for the physical layer device associated with that queue. Each packet has a priority level associated therewith and a weight indicative of the priority level of that packet. The scheduler block also includes a shaper that retrieves packets from the queues and forwards the packets to the interface. The order in which the packets are retrieved from the plurality of queues is based on the weight assigned to each packet. For each physical layer device, the shaper shapes the packets retrieved from the queue associated with that physical layer device based on a data rate for that physical layer device.

### TECHNICAL FIELD

The following description relates to telecommunications in general and to asynchronous transfer mode (ATM) devices in particular.

### BACKGROUND

Telecommunications networks typically use various multiplexing schemes to combine multiple data streams for transmission over a single physical transmission medium (also referred to here as a “link”). These schemes can be categorized into one of a number of different types. One scheme is time division multiplexing (TDM), which is commonly used in circuit-based applications.

In a TDM scheme, the single link has a data rate that is higher than the data rate of any of the multiple data streams that are to be combined. Typically, the link has a data rate that is at least N×f, where N is the number of data streams to be combined for transmission on the links and f is the data rate of each lower-speed, data stream. Each lower-speed data stream is assigned a fixed time slot during which only data from that input data stream can be transmitted on the link. This is the case regardless of whether or not that particular data stream actually has any data to be transmitted on the link during the time slot assigned to that data stream.

TDM multiplexing has been used in telecommunications networks for many years and serves as the basis for plesiosynchronous digital hierarchy (PDH) and synchronous digital hierarchy (SDH) technology. In both PDH and SDH technology, a higher speed link is divided into time slots or containers at fixed time intervals. These time slots are used for transporting telephone conversations, which are generally considered “synchronous” traffic; that is, the information is transmitted at regular intervals.

Other multiplexing schemes are more suitable for other types of data traffic. For example, data traffic tends to be “bursty.” That is, a given stream of data traffic is typically made up of bursts of data in between idle periods in which no data is transmitted. Combining multiple bursty data streams using a TDM scheme can cause bandwidth to be wasted. Bandwidth is wasted when no data is transmitted during a given time slot.

Other multiplexing schemes attempt to alleviate this issue with bursty traffic by transmitting data on the link only when there actually is data to be transferred for a give data stream. One such common multiplexing scheme is asynchronous transfer mode (ATM). ATM is commonly used in wide area telecommunications networks. In an ATM multiplexing scheme, data is partitioned into fixed size cells. Each cell has a fixed size header containing addressing, priority, error checking, and other routing information.

One common design goal of telecommunication service providers is to have a single network that is suited for transmission of both synchronous and bursty traffic. To this end, provisions were included in the definition of ATM to help make ATM suited for all types of network traffic. Within ATM, cells transported over the same link with the same header form a connection also referred to here as a “virtual circuit” or “VC”. When a connection is established and the data path is setup, a quality of service (QOS) is specified for that connection. The QOS determines the traffic characteristics of the connection. For example, synchronous traffic typically cannot tolerate varying delay and therefore is typically assigned a constant bit rate (CBR) QOS. A CBR QOS indicates that cells for that synchronous connection should be transferred through the switching and multiplexing equipment with a minimum delay and at a constant rate. Data or file transfer traffic (that is, bursty traffic) is typically assigned an unspecified bit rate (UBR) QOS. An UBR QOS indicates that cells for that connection should be transferred at a lower priority, without much concern for minimizing delay, and only when switching resources are available. Through the definition of these and other QOS levels, ATM equipment can handle different types of traffic.

ATM functions used to guarantee that QOS objectives are met include scheduling and shaping functions. Unlike in TDM schemes, the cells transmitted in ATM have no fixed time slot and can arrive at irregular intervals. The scheduling and shaping functions are traffic management functions that manage the transmission of cells from different connections. Cells from different connections are scheduled to insure that “higher priority” connections are transmitted first or at regular intervals. In addition, the combined rate of all the connections on a single link is shaped to guarantee that the combined rate does not exceed the physical data rate of the link.

Typically, these functions are implemented as scheduler blocks in one or more ATM processor semiconductor devices. FIG. 1 is a block diagram illustrating one embodiment of a prior art scheduler block 100. Each scheduler block 100 contains multiple queues 102. Each queue 102 is associated with one of multiple QOS types. The scheduler block 100 also includes shaper 104 that determines when each cell stored in the queues 102 should be read out of its queue 102. At a time determined by the logic 104 for each cell, the shaper 104 reads the cell from its queue 102 and outputs the cell on an output interface (also referred to here as a “port”) 106 coupled to a physical layer termination device 108 (for example, a physical layer termination device supporting the UTOPIA physical layer protocol). For example, in one implementation, a weighted round robin scheme is used for scheduling when cells are read out of each queue 102.

In the embodiment shown in FIG. 1, a queue 102 is allocated for each QOS type, including CBR, UBR, real time variable bit rate (rt-VBR), non-real time variable bit rate (nrt-VBR), and available bit rate (ABR). These different QOS types are specified in the ATM standards. Within each queue 102 (that is, for each QOS), the connections stored in that queue 102 are assigned a weight based on the traffic parameters specified when each connection was setup. This is done to establish a relative priority between the connections. The assigned weights determine when cells are read out of the queue 102. The scheduler 100 shapes the aggregate traffic flow so as not to exceed the data rate of the physical layer termination device 108 link coupled to the port 106. In one embodiment, the physical layer termination device 108 (such as a digital subscriber line (DSL) chipset that support the UTOPIA physical layer protocol) is coupled to the port 106 over a bus 110 (for example, a bus that supports the UTOPIA physical layer protocol). Each port 106 has an address on the bus 110.

ATM multiplexer equipment such as digital subscriber loop access multiplexer (DSLAM) and broadband digital loop carrier (broadband DLC) equipment generally must support many physical layer termination devices, and hence need many schedulers. One approach is to use one scheduler block for each physical layer termination device. This, however, increases the cost of the equipment.

Alternatively, a single scheduler block can be used for multiple physical layer termination devices. FIG. 2 is a block diagram of one embodiment of such a prior art scheduler block 200. Cells intended for all of the multiple physical layer termination devices 208 are output on the same port 206 having a single port address. A switching device 212 external to the scheduler block 200 is used to route or switch the cells and connections to appropriate physical layer termination devices 208 based on each cell's ATM header.

In this embodiment, the output of the scheduler block 200 is shaped to the combined rate of the multiple physical layer termination devices 208. For example, in the embodiment shown in FIG. 2, if each of four physical layer termination devices 208 has a data rate of 8 megabits-per-second (Mbps), then the combined data rate of the four physical layer termination devices 208 is 32 Mbps. However, in this case, if a single 32 Mbps burst is to be scheduled for one physical layer termination device 208, when no other cells are available for the other physical layer termination devices 208, the entire burst will pass the shaper 204 of the scheduler block 200 and will be dropped at the physical layer termination device 208 where, unless additional cell prioritization hardware is used, it may not be possible to differentiate between different QOS types. Thus, it is difficult to guarantee the connection prioritization and performance per connection.

### SUMMARY

In one embodiment, a scheduler block includes a plurality of queues. Each queue is associated with at least one of a plurality of physical layer devices. Each queue stores packets intended for the physical layer device associated with that queue. Each packet has a priority level associated therewith and a weight indicative of the priority level of that packet. The scheduler block further includes an interface adapted to communicate with the plurality of physical layer devices. The scheduler block further includes a shaper, coupled to the plurality of queues and to the interface, that retrieves packets from the plurality of queues and forwards the packets to the interface. The order in which the packets are retrieved from the plurality of queues is based on the weight of each packet. For each physical layer device, the shaper shapes the packets retrieved from the queue associated with that physical layer device based on a data rate for that physical layer device.

In another embodiment, a method of forwarding scheduling packets, each packet intended for at least one of a plurality of physical layer devices and each packet being associated with a connection having a priority level, includes assigning each connection in a queue a weight related to the priority level of the queue. The method further includes, when a packet is received, enqueueing the received packet in the queue associated with the physical layer device to which the received packet is intended. The method further includes reading packets out of the plurality of queues in accordance with the weights assigned to the connections and shaping the packets read out of each queue to the data rate of the physical layer device associated with that queue. The method further includes outputting the packets.

In another embodiment, an access system includes a first unit including a first scheduler that performs traffic parameter based on scheduling for the access system. The access system further includes a plurality of second units coupled to the first unit. Each second unit includes a second scheduler block having a plurality of queues. Each queue is associated with at least one of a plurality of physical layer devices. Each queue stores packets intended for the physical layer device associated with that queue. Each packet has a priority level associated therewith and a weight indicative of the priority level of that packet. Each second unit further includes an interface adapted to communicate with the plurality of physical layer devices, and a shaper, coupled to the plurality of queues and to the interface, that retrieves packets from the plurality of queues and forwards the packets to the interface. The order in which the packets are retrieved from the plurality of queues is based on the weight of each packet. For each physical layer device, the shaper shapes the packets retrieved from the queue associated with that physical layer device based on a data rate for that physical layer device.

In another embodiment, a method of forwarding scheduling packets, each packet intended for at least one of a plurality of physical layer devices and each packet being associated with a connection having a priority level, includes, at a first unit, performing traffic parameter-based scheduling. The method further includes, at a second unit, assigning each connection in a queue a weight related to the priority level of the queue, and, when a packet is received, enqueueing the received packet in the queue associated with the physical layer device to which the received packet is intended. The method further includes, at the second unit, reading packets out of the plurality of queues in accordance with the weights assigned to the connections, shaping the packets read out of each queue to the data rate of the physical layer device associated with that queue, and outputting the packets. The second unit receives packets from the first unit in accordance with the traffic parameter-based scheduling.

The details of one or more embodiments of the claimed invention are set forth in the accompanying drawings and the description below. Other features and advantages will become apparent from the description, the drawings, and the claims.

### DRAWINGS

FIG. 1 is a block diagram illustrating one embodiment of a prior art scheduler block.

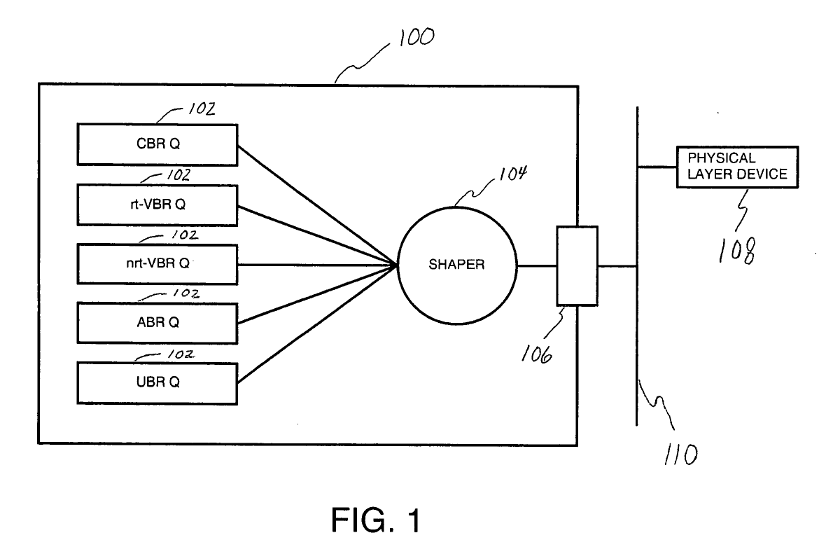

FIG. 2 is a block diagram of one embodiment of a prior art scheduler block.

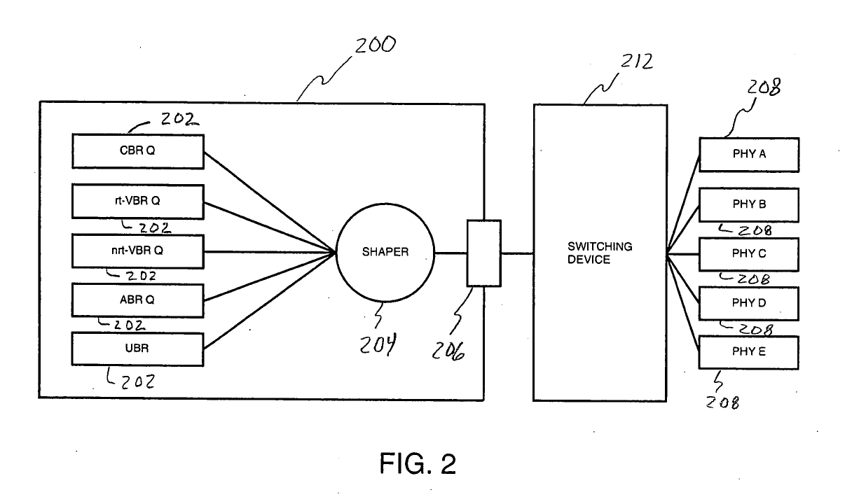

FIG. 3 is a block diagram of one embodiment of a scheduler block.

FIG. 4 is a flow diagram of one embodiment of a method 400 of scheduling and shaping packets.

FIG. 5 is a high-level block diagram of one embodiment of an ATM access system.

FIG. 6 is a flow diagram of one embodiment of a method 600 of scheduling and shaping packets.

Like reference numbers and designations in the various drawings indicate like elements.

### DETAILED DESCRIPTION

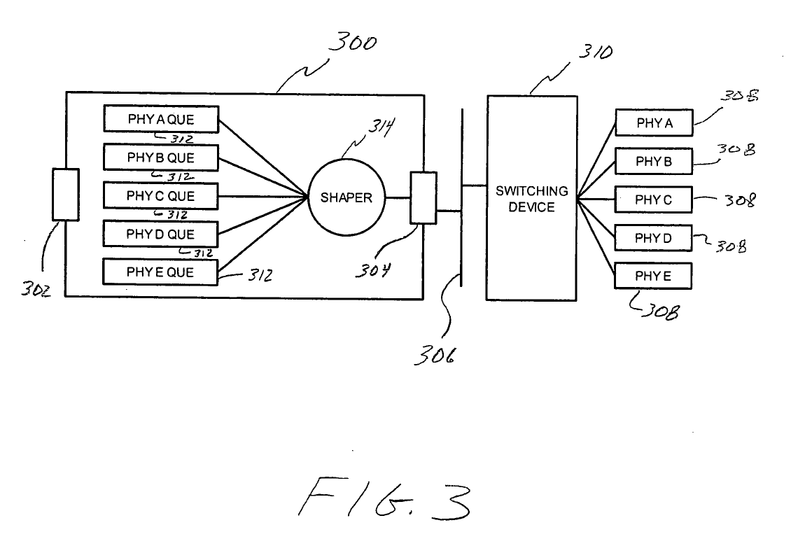

FIG. 3 is a block diagram of one embodiment of a scheduler block 300. The embodiment of scheduler block 300 is described here as being implemented so as to schedule ATM cells. It is to be understood, however, that in other embodiments other types of packets (for example, ETHERNET packets) are scheduled. Each scheduler block 300 contains at least one input interface (or port) 302 and at least one output interface (or port) 304. Cells (or other types of packets) are received on the input interface 302 and cells are transmitted out on the output interface 304. In the embodiment shown in FIG. 3, the output interface 304 couples the block 300 to a bus 306. Multiple physical layer termination devices 308 are coupled to a cell switching device 310. The cell switching device 310 is coupled to the scheduler block 300 over the bus 306. In one implementation, the input interface 302 and the output interface 304 are UTOPIA interfaces and the bus 306 is a UTOPIA bus. In one implementation, the physical layer termination devices 308 comprise DSL line units (also referred to here as “DSL line cards”) such as asynchronous digital subscriber line (ADSL) line cards, G. SHDSL line cards, and VHDSL line cards.

Scheduler block 300 includes multiple queues 312. Each queue 312 is associated with a particular physical layer device 308. For example, in the embodiment shown in FIG. 3, the scheduler block 300 includes five queues 312. Each queue 312 is associated with one of five physical layer termination devices 308. Each cell (or other data packet) received on the input interface 302 is intended for a particular physical layer termination device 308 and is enqueued in the queue 312 associated with that physical layer termination device 308.

The scheduler block 300 also includes a shaper 314 that is coupled to each of the queues 312. Shaper 314 retrieves cells from the queues 312 according to a weighted round robin scheme. Each connection has a “weight” assigned to that connection. The shaper 314 retrieves cells from the queues 312 in accordance with these weights in order to maintain the QOS levels of each connection.

In addition, the shaper 314, for each queue 312 that the shaper 314 reads cells from, also shapes the cells read from that queue 312 to the data rate of the physical layer device 308 associated with that queue 312. In one implementation, the cells read out of each queue are shaped according to a weighted round robin (WRR) algorithm in accordance with standards promulgated by the ATM Forum.

In one embodiment, the scheduler block 300 is implemented as one or more application-specific integrated circuits (ASIC). Other embodiments are implemented in other ways, for example, using a field programmable gate array (FPGA), discrete components, programmable processors and the like.

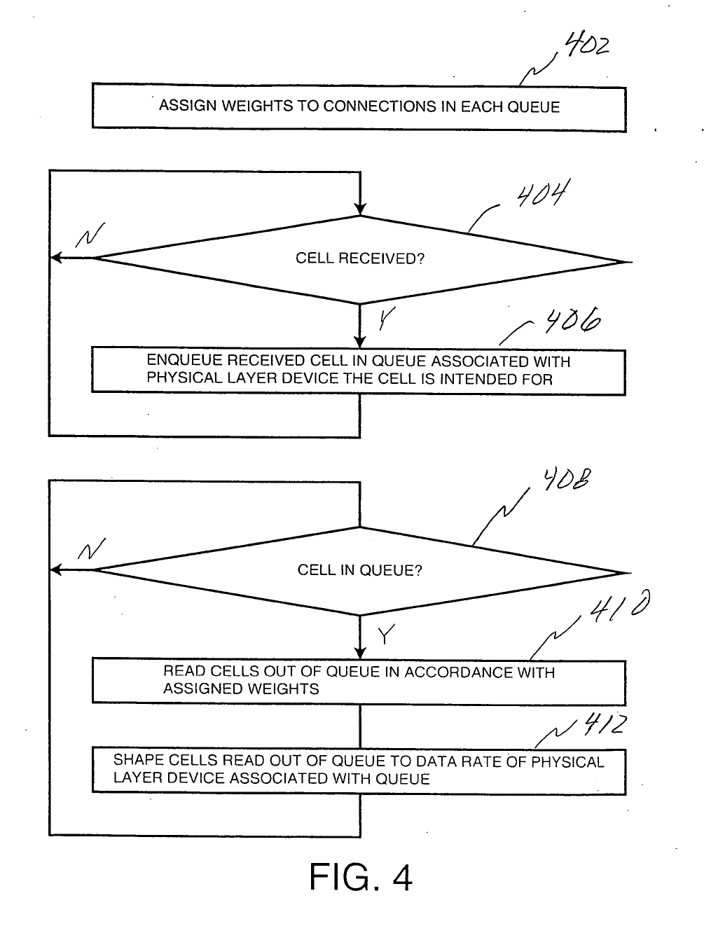

FIG. 4 is a flow diagram of one embodiment of a method 400 of scheduling and shaping packets such as ATM cells. Method 400 is suitable for use with embodiments of the scheduler block 300 for scheduling and shaping ATM cells. Although the embodiment shown in FIG. 4 is described here as being used to schedule and shape ATM cells, it is to be understood that other embodiments are used to schedule and shape other types of packets such as ETHERNET packets. Each cell or data packet is intended for a particular physical layer termination device. Each connection that each cell is a part of has an associated quality of service or other indication of relative priority.

Method 400 includes assigning each connection in a queue a weight related to the QOS of that connection (or other priority) (block 402). Weights are assigned to maintain the relative priority of the connections. For example, in one implementation, a connection having a CBR QOS is assigned a weight that is twice as large as the weight assigned to a connection having a UBR QOS.

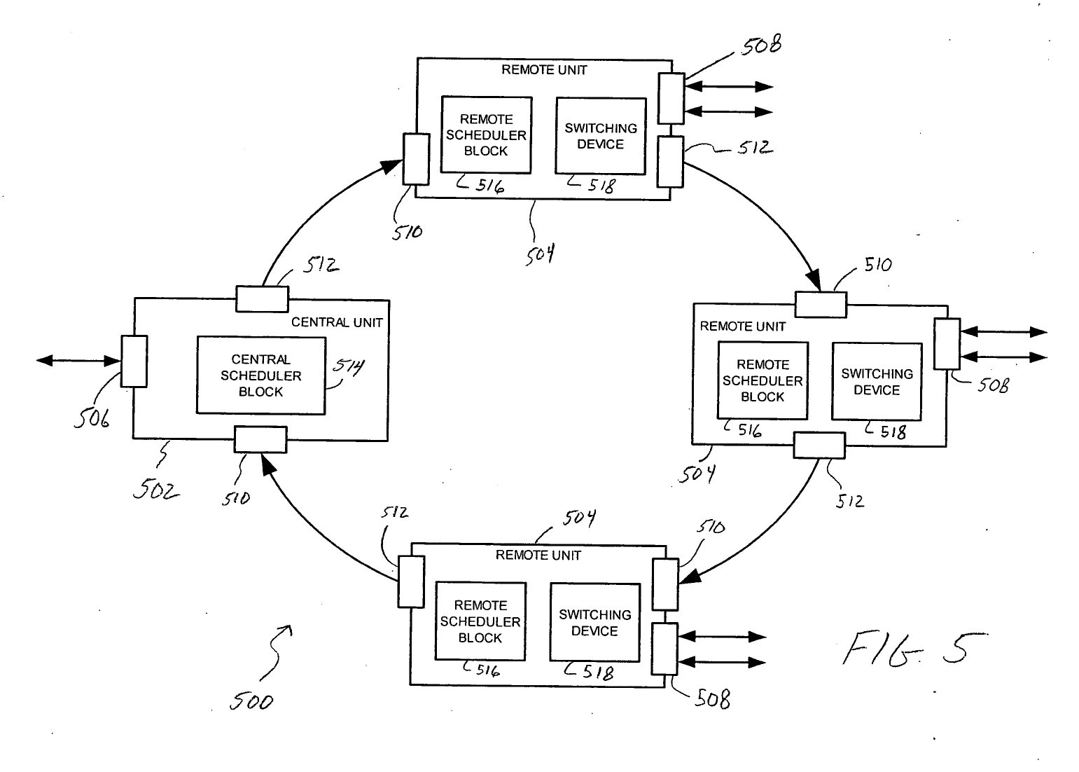

When a cell is received (determined in block 404), the received cell is enqueued in the queue associated with the physical layer termination device for which the cell is intended (block 406). In one embodiment, another device (for example, a central unit described below in connection with FIG. 5) performs traffic-parameter-based scheduling and provides the cells to the input interface 302 of the scheduler block 300 in accordance with the results of that scheduling.

When a cell is in a queue (which is checked in block 408), cells are read out of the queues in accordance with the assigned weights (block 410). For example, in one embodiment, the cells are read out of the queues in accordance with a weighted round robin scheme as described above. The cells read out of each queue are shaped to the data rate of the physical layer termination device 308 associated with that queue (block 412). In one implementation, the cells read out each queue are shaped according to a WRR in accordance with standards promulgated by the ATM Forum. In one embodiment, the operations of block 408, block 410, and block 412 are performed in parallel with the operations of block 402, block 404, and block 406, for example, by using dual-ported random access memory (RAM).

With embodiments of the scheduler block 300 and method 400, data flows intended for different physical layer termination devices need not affect each other, and limited bursts will be shaped so that the physical layer termination device are better able to handle the burst without loss. Each of the queues 312 is associated with, and serves, a separate physical layer termination device. In other words, in a network device in which thirty two scheduler blocks 300 are used, where each block has five queues data streams intended for one hundred sixty physical layer termination devices (in other words, thirty two times five) are supported. Such an approach can reduce the costs associated with providing such scheduling and shaping functionality.

FIG. 5 is a high-level block diagram of one embodiment of an ATM access system 500. The embodiment of access system 500 shown in FIG. 5 is implemented using embodiments of scheduler block 300 of FIG. 3 and method 400 of FIG. 4. Although a ring topology is shown in FIG. 5, it is to be understood that other topologies, such as hub/star, linear, and the like, are used in other embodiments.

Access system 500 includes a central unit 502 and multiple remote units 504. The central unit 502 includes a network interface (for example, a network-node interface (NNI) or user-network interface (UNI)) 506 that couples the central unit and the access system 500 to an ATM network (not shown). For example, in one embodiment, a SONET ring is coupled to the network interface 506. Each of the remote units 504 includes multiple user interfaces (UNIs) 508. Each user interface 508 couples a remote unit 504 and the access system 500 to one of multiple edge devices (not shown). For example, in one embodiment, an asynchronous digital subscriber line (ADSL) modem or a broadband integrated services digital network (B-ISDN) modem is coupled to at least one of the user network interfaces 508. The central unit 502 and each of the remote units 504 includes an input inter-unit interface 510 and an output inter-unit interface 512 that are used to couple each unit to two other units in the ring. For each unit in the access system 500, cells are received from another unit over the input inter-unit interface 510 and cells are transmitted to another unit over the output inter-unit interface 512. In one embodiment, the network interface 506 is a point-to-point SONET UNI/NNI, the inter-unit interfaces 510 and 512 are SDH/ATM interfaces, and the user network interfaces 508 include ADSL and/or B-ISDN interfaces.

The central unit 502 includes at least one central scheduler block 514 that perform all traffic parameter-based scheduling for the access system 500. Cells received from the network interface 506 and the input inter-unit interface 510 are scheduled, shaped, and ultimately output by the central unit 502 on the network interface 506 and the output inter-unit interface 512 as appropriate. The central scheduler block 514 performs full traffic parameter-based scheduling for the cells the central scheduler block 514 processes.

Each remote unit 504 includes at least one remote scheduler block 516. Remote scheduler block 516 is an embodiment of the scheduler block 300 of FIG. 3. Cells received from the input inter-unit interface 510 and the user interfaces 508 are processed in accordance with an embodiment of method 400 of FIG. 4. In other words, each connection has a weighted assigned to that connection based on the QOS of that connection, which in one implementation is determined using the virtual circuit identifier (VCI) and/or virtual path identifier (VPI) fields of the cell header. The weights are assigned to preserve scheduling performed by the central scheduler block 516. The remote unit 504 also includes an ATM switching device 518 that is coupled to an output of the scheduler block 516. The ATM switching device 518 routes or switches cells and connections output by the remote scheduler block 516 to an appropriate user interface 508 or the output inter-unit interface 512 based on each cells ATM header.

In one embodiment, each remote unit 504 includes an ATM interface card and one or more ADSL or B-ISDN line interface cards. In such an embodiment, the ATM scheduling card includes the remote scheduler block 516, the input inter-unit interface 510, the output inter-unit interface 512, and the ATM switching device 518. Alternatively, the inter-unit interfaces 510 and 512 can be on different cards. Each line interface card in such an embodiment includes the user interfaces 508. In such an embodiment, the ATM interface card and the one or more ADSL or B-ISDN line interface cards are coupled to each other over a backplane.

The traffic management parameters are processed in the central unit 502, while the remote units 504 need not be designed to carry out such processing of traffic management parameters. The remote units 504, therefore, can be relatively simple and have static configurations that assign appropriate weights (for example, low or high weights) to preserve the scheduling done at the central unit 502. Such an approach reduces the need to manage many configuration tables in the central unit 502 and the remote units 504. Instead, a single configuration table is managed at the central unit 502, while the remote unit's simply assign the appropriate weight based on the QOS type that is identified by the VPI or VCI in the cell header.

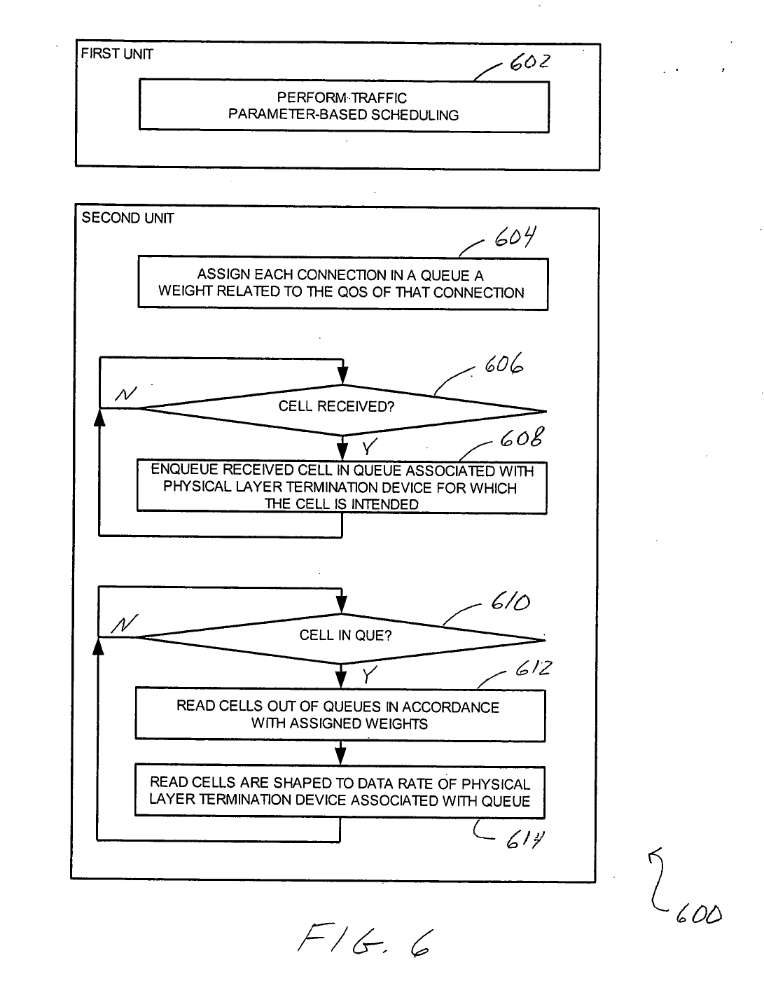

FIG. 6 is a flow diagram of one embodiment of a method 600 of scheduling and shaping packets such as ATM cells. Method 600 is suitable for use with embodiments of the scheduler block 300 and access system 500 for scheduling and shaping ATM cells. Each cell or packet is intended for a particular physical layer termination device. Each connection that each cell is a part of has an associated quality of service or other indication of relative priority.

Method 600 includes, at a first unit, performing traffic parameter-based scheduling (block 602). In an embodiment implemented using an embodiment of access system 500, traffic parameter-based scheduling is performed in central unit 502 by central scheduler block 514. For example, in an implementation of such an embodiment, during setup each connection is assigned an ATM layer service category which best complies with the connection's required QOS and the expected behavior of the connection. The service category dictates which connection traffic parameters are specified and the QOS objectives. Once established, the central unit 502 monitors the connection and schedulers cells to attempt to ensure that the connection conforms to the traffic parameters.

Method 600 also includes operations executed at a second unit. Method 600 includes, at the second unit, assigning each connection in a queue a weight related to the QOS of that connection (or other priority) (block 604). Weights are assigned to maintain the relative priority of the connections. For example, in one implementation, a connection having a CBR QOS is assigned a weight that is twice as large as the weight assigned to a connection having a UBR QOS.

At the second unit, when a cell is received (determined in block 606), the received cell is enqueued in the queue associated with the physical layer termination device for which the cell is intended (block 608). The first unit performs traffic-parameter-based scheduling and provides the packets (for example, ATM cells) cells to the second unit in accordance with the results of that scheduling.

When a cell is in a queue at the second unit (which is checked in block 610), cells are read out of the queues in accordance with the assigned weights (block 612). For example, in one embodiment, the cells are read out of the queues in accordance with a weighted round robin scheme as described above. The cells read out of each queue are shaped to the data rate of the physical layer termination device associated with that queue (block 614). In one implementation, the cells read out each queue are shaped according to a WRR in accordance with standards promulgated by the ATM Forum. In one embodiment, the operations of block 610, block 612, and block 614 are performed at the second unit in parallel with the operations of block 604, block 606, and block 608, for example, by using dual-ported random access memory (RAM).

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. For example, although embodiments involving scheduling and shaping ATM cells are described above, it is to be understood that other types of packets are used in other embodiments. Accordingly, other embodiments are within the scope of the following claims.

1. A scheduler block, comprising:
a plurality of queues, wherein each queue is associated with at least one of a plurality of physical layer devices, wherein each queue stores packets intended for the physical layer device associated with that queue, and wherein each packet has a priority level associated therewith and a weight indicative of the priority level of that packet;
an interface adapted to communicate with the plurality of physical layer devices; and
a shaper, coupled to the plurality of queues and to the interface, that retrieves packets from the plurality of queues and forwards the packets to the interface, wherein the order in which the packets are retrieved from the plurality of queues is based on the weight of each packet; and
wherein, for each physical layer device, the shaper shapes the packets retrieved from the queue associated with that physical layer device based on a data rate for that physical layer device.

2. The scheduler block of claim 1, wherein each packet is a part of a connection and wherein the priority level and weight associated with each packet is associated with the connection that the packet is a part of.

3. The scheduler block of claim 1, wherein the interface is adapted to couple the scheduler block to a switching device that is coupled to the plurality of physical layer devices.

4. The scheduler block of claim 1, wherein the interface is a UTOPIA interface.

5. The scheduler block of claim 1, wherein the plurality of physical layer devices include asynchronous digital subscriber line devices.

6. The scheduler block of claim 1, wherein the plurality of physical layer devices include broadband integrated service digital network devices.

7. The scheduler block of claim 1, wherein the packets are retrieved from the plurality of queues according to a weighted round robin scheme.

8. The scheduler block of claim 1, wherein the packets include at least one of ATM cells and ETHERNET packets.

9. The scheduler block of claim 1, wherein, for each of the plurality of physical layer devices, the shaper shapes the packets retrieved from the queue associated with that physical layer device according to a generic cell rate algorithm.

10. A method of forwarding scheduling packets, each packet intended for at least one of a plurality of physical layer devices and each packet being associated with a connection having a priority level, the method comprising:
assigning each connection in a queue a weight related to the priority level of the queue;
when a packet is received, enqueueing the received packet in the queue associated with the physical layer device to which the received packet is intended;
reading packets out of the plurality of queues in accordance with the weights assigned to the connections;
shaping the packets read out of each queue to the data rate of the physical layer device associated with that queue; and
outputting the packets.

11. The method of claim 10, wherein outputting the packets includes outputting the packets to a switching device, wherein the switching device forwards each packet to the physical layer device for which that packet is intended.

12. The method of claim 11, wherein the switching device is coupled to a UTOPIA interface and outputting the packets to the switching device includes outputting the packets on the UTOPIA interface.

13. The method of claim 10, wherein enqueueing the received packets occurs in parallel with reading cells out of the plurality of queues, shaping the cells read out of each queue, and outputting the packets.

14. The method of claim 10, wherein the plurality of physical layer devices include asynchronous digital subscriber line devices.

15. The method of claim 10, wherein the plurality of physical layer devices include broadband integrated service digital network devices.

16. The method of claim 10, wherein reading packets out of the plurality of queues in accordance with the assigned weights includes reading packets out of the plurality of queues in accordance with a weighted round robin scheme.

17. The method of claim 10, wherein the packets include at least one of ATM cells and ETHERNET packets.

18. The method of claim 10, wherein shaping the packets read out of each queue to the data rate of the physical layer device associated with that queue includes shaping the packets read out of each queue according to a generic cell rate algorithm.

19. An access system, comprising:
a first unit including a first scheduler that performs traffic parameter based on scheduling for the access system;
a plurality of second units coupled to the first unit, each second unit including a second scheduler block having:
a plurality of queues, wherein each queue is associated with at least one of a plurality of physical layer devices, wherein each queue stores packets intended for the physical layer device associated with that queue, and wherein each packet has a priority level associated therewith and a weight indicative of the priority level of that packet;
an interface adapted to communicate with the plurality of physical layer devices;
a shaper, coupled to the plurality of queues and to the interface, that retrieves packets from the plurality of queues and forwards the packets to the interface, wherein the order in which the packets are retrieved from the plurality of queues is based on the weight of each packet; and
wherein, for each physical layer device, the shaper shapes the packets retrieved from the queue associated with that physical layer device based on a data rate for that physical layer device.

20. The access system of claim 19, wherein the first unit is a central unit and the first scheduler block is a central scheduler block.

21. The access system of claim 19, wherein each second unit is a remote unit and each second scheduler block is a remote scheduler block.

22. The access system of claim 19, wherein the interface is adapted to couple the second scheduler block to a switching device that is coupled to the plurality of physical layer devices.

23. The access system of claim 19, wherein the interface comprises at least one of an SDH interface and a SONET interface.

24. The access system of claim 19, wherein the plurality of physical layer devices include asynchronous digital subscriber line devices.

25. The access system of claim 19, wherein the plurality of physical layer devices include broadband integrated service digital network devices.

26. The access system of claim 19, wherein the packets are retrieved from the plurality of queues according to a weighted round robin scheme.

27. The access system of claim 19, wherein the packets include at least one of ATM cells and ETHERNET packets.

28. The access system of claim 19, wherein, for each of the plurality of physical layer devices, the shaper shapes the packets retrieved from the queue associated with that physical layer device according to a weighted round robin algorithm.

29. The access system of claim 19, wherein the access system has a ring topology.

30. A method of forwarding scheduling packets, each packet intended for at least one of a plurality of physical layer devices and each packet being associated with a connection having a priority level, the method comprising:
at a first unit, performing traffic parameter-based scheduling;
at a second unit:
assigning each connection in a queue a weight related to the priority level of the queue;
when a packet is received, enqueueing the received packet in the queue associated with the physical layer device to which the received packet is intended;
reading packets out of the plurality of queues in accordance with the weights assigned to the connections;
shaping the packets read out of each queue to the data rate of the physical layer device associated with that queue; and
outputting the packets; and
wherein the second unit receives packets from the first unit in accordance with the traffic parameter-based scheduling.

31. The method of claim 30, wherein outputting the packets includes outputting the packets to a switching device, wherein the switching device forwards each packet to the physical layer device for which that packet is intended.

32. The method of claim 31, wherein the switching device is coupled to a UTOPIA interface and outputting the packets to the switching device includes outputting the packets on the UTOPIA interface.

33. The method of claim 30, wherein the first unit is a central unit of an access system.

34. The method of claim 30, wherein the second unit is a remote unit of an access system.

35. The method of claim 30, wherein enqueueing the received packets occurs at the second unit in parallel with reading cells out of the plurality of queues, shaping the cells read out of each queue, and outputting the packets.

36. The method of claim 30, wherein the plurality of physical layer devices include asynchronous digital subscriber line devices.

37. The method of claim 30, wherein the plurality of physical layer devices include broadband integrated service digital network devices.

38. The method of claim 30, wherein reading packets out of the plurality of queues in accordance with the assigned weights includes reading packets out of the plurality of queues in accordance with a weighted round robin scheme.

39. The method of claim 30, wherein the packets include at least one of ATM cells and ETHERNET packets.

40. The method of claim 30, wherein shaping the packets read out of each queue to the data rate of the physical layer device associated with that queue includes shaping the packets read out of each queue according to a weighted round robin algorithm.
